(19) United States
(12) Patent Application Publication
(10) Pub. No.: US 2017/0026636 A1
(43) Pub. Date: Jan. 26, 2017

(54) METHOD FOR THE POSITIONALLY ACCURATE PROJECTION OF A MARK ONTO AN OBJECT, AND PROJECTION APPARATUS

(71) Applicant: Testo AG, Lenzkirch (DE)

(72) Inventors: Patrick Zahn, Titsee-Neustadt (DE); Martin Stratmann, Freiburg (DE)

(73) Assignee: Testo AG, Lenzkirch (DE)

(21) Appl. No.: 15/102,656

(22) PCT Filed: Dec. 12, 2013
(86) PCT No.: PCT/EP2013/003760

§ 371 Date: Jun. 8, 2016

(51) Int. Cl. H04N 13/02; G01C 15/00; G06T 7/00; G01C 15/02

(52) U.S. Cl. CPC H04N 13/0296; G01C 15/02; G01C 15/002; G06T 7/0042; G06T 7/0057; H04N 13/0253; G06T 2207/30208

(57) ABSTRACT

Disclosed is a projection apparatus (1) in which a capturing and/or measuring device (2) is used for measuring a three-dimensional position and/or orientation of an object (3), a projection pose of a projector (4) is calculated from the result of said measurement, and the projector (4) is oriented in such a way that a mark (20) predefined in a 2D or 3D model (13) of the object (3) is projected in a positionally accurate manner onto the object (3).

### BACKGROUND

The invention relates to a method for the positionally accurate projection of a mark onto an object.

The invention also relates to a projection apparatus having a recording and/or measuring apparatus and a projector, the projector being coupled to the recording and/or measuring apparatus in such a manner that a defined spatial orientation of the projector is predefined or can be predefined by a spatial orientation of the recording and/or measuring apparatus.

WO 2011/082754 A1 discloses a projection apparatus, with which a measurement result can be obtained from an object, can be converted into a false color representation and can be projected back onto the object as a false color representation. In this case, positionally accurate projection of the false color representation is achieved by virtue of the projection being matched to the recording optics.

The present invention is also based on a method with a corresponding apparatus according to DE 10 2013 009 288.4, according to which a 3-D model with associated scaling of the model is calculated from an examined object by recording a series or sequence of two-dimensional images of the object, from which an unscaled 3-D model is calculated, the 3-D model having been scaled by measuring a distance. Projection of information onto the object is not provided.

Another starting point of the invention is a method according to DE 10 2009 050 474 A1, in which meta data associated with a recorded thermal image are inserted into the display in a spatially associated manner.

### SUMMARY

The invention is based on the object of specifying a method for the positionally accurate projection of a mark onto an object.

In order to achieve this object, the features are provided according to the invention in a method for the positionally accurate projection of a mark onto an object. In particular, in order to achieve the object mentioned in a method of the type described at the outset, the invention therefore provides that at least the following steps are carried out:
providing a 2-D or 3-D model of the object in a computer-assisted manner,
predefining at least one mark in the 2-D or 3-D model,
measuring a spatial position and/or orientation of the object,
determining a projection pose of the projector with respect to the measured spatial position and/or orientation of the object in a computer-assisted manner by comparing a measurement result of the measurement with the 2-D or 3-D model,
adjusting the projector on the basis of the projection pose for positionally accurate projection of the at least one mark onto the object, and
projecting the at least one mark onto the object in a positionally accurate manner on the basis of the calculated control.

In this case, the model may be present in two-dimensional form as a 2-D model. This variant may be expedient, for example, if the object has a flat shape, which may be the case for a room wall, for example. The model may also be present as a 3-D model with three-dimensional position indications. This is particularly advantageous when the object has a spatial structure or generally a complex structure.

The method according to the invention may provide for the 2-D or 3-D model to be automatically created with the aid of distance measurements, for example.

The projector can be adjusted according to the invention in this case by orienting the projector, for example, in such a manner that the projection direction results in positionally accurate projection. Alternatively or additionally, the projector can be adjusted according to the invention by setting up the projector, for example by controlling a projection matrix or a projection mask or at least one adjustable mirror, for example a micro-mirror which can be pivoted in one or two directions, in order to obtain the positionally accurate projection of the mark. The at least one pivotable micro-mirror may be designed using MEMS technology, for example.

The steps mentioned can be carried out in the cited sequence or in any desired other sequence which is logically possible. However, the sequence of the individual steps which is given by the list is the preferred embodiment.

The projection pose is used to describe the position and the orientation of the projector in a manner known per se. The invention makes it possible to project a predefined mark in a 2-D or 3-D model of an object onto the object in such a manner that the impingement point of the mark on the object matches the position of this mark in the 2-D or 3-D model. In this case, the projection pose of the projector is determined in a computer-assisted manner in a manner known per se according to given perspective and geometrical laws by virtue of the measurement result recorded using the recording and/or measuring apparatus, for example an image or a three-dimensional representation of the object, being compared with the 2-D or 3-D model, for example by virtue of a corresponding, simulated measurement result being derived from the 2-D or 3-D model assuming a particular projection pose. The actual projection pose is then that projection pose for which the derived simulated measurement result matches the measurement result actually obtained. The projector can be adjusted, for example, by moving, pivoting or tilting or rotating the projector or by means of movable parts of the projector such as mirrors and the like.

In the invention, the mark can be predefined as a point, a line, a circle, an area or another simple or more complex geometrical shape in the 2-D or 3-D model. For example, wiring diagrams or circuit diagrams can be projected in this way in a positionally accurate manner onto objects on which these diagrams are intended to be achieved or implemented. For example, desired clearances with respect to features of the object can also be removed in this manner by the positionally accurate projection on the object. This is because the positionally accurate projection also results in a representation of desired lines, circles or other patterns in a form true to scale.

In order to measure the spatial position and/or orientation, one configuration of the invention may provide for at least one distance between a projection apparatus having the projector and the object to be measured. In this case, it is advantageous that an item of information relating to the distance and therefore the actual size of the examined object can be obtained, for example for scaling of the 2-D or 3-D model. This is particularly favorable when no absolute size information relating to the 3-D model is available.

In this case, it is particularly favorable if more than one distance, for example two distances, three distances or more than three distances, from different points on the object is measured. In this case, it is advantageous that information relating to the position and/or orientation of the object with respect to the location of the recording and/or measuring apparatus can be immediately obtained. In the case of areal objects for example, it is often sufficient to measure three distances in order to determine the position of the object in space and the orientation with respect to the recording and/or measuring apparatus.

It is particularly favorable if the object is scanned in order to measure a multiplicity of distances in a point grid on the object.

In order to measure the spatial position, one configuration of the invention may provide for a three-dimensional representation of the object to be calculated from a distance, for example the already mentioned at least one distance, between a projection apparatus having the projector and the object and/or from a sequence of recorded images of the object and to be compared with the 2-D or 3-D model. Alternatively or additionally, in order to measure the spatial position, provision may be made for a three-dimensional representation of the object to be calculated from a sequence of recorded images of the object and to be compared with the 2-D or 3-D model: this can be carried out, for example, by solving a system of equations describing the images in the sequence which are recorded from different positions as projections of the object. The images are preferably recorded from different recording angles using a camera described further below.

In these alternatives, it is advantageous that information relating to the projection pose can be immediately obtained by virtue of the fact that a spatial position and orientation of the object with respect to the projection apparatus and therefore, vice versa, a spatial position and orientation of the projection apparatus can be calculated by comparing the shapes of the 2-D or 3-D model, on the one hand, and the three-dimensional representation from the distance measurements and/or the sequence of images, on the other hand, with one another using known geometrical laws of spatial geometry. In this case, it is particularly favorable if the three-dimensional representation has been obtained from a multiplicity of distance measurements, for example by scanning the object in the described manner. In this case, the scanning process can be carried out by means of a line scan or column scan or by projecting different patterns and evaluating the patterns distorted by a surface of the object or in another manner.

In order to measure the spatial position and/or orientation of the object, one configuration of the invention may provide for at least one feature of the object to be detected. The at least one feature may be, for example, an edge, a corner, a point, a line and/or another mark. The detection can be carried out by means of scanning. Feature descriptors which can be used to detect or scan the object respectively exist for the features mentioned and for further features. It is generally known practice to use descriptors for two-dimensional corners, that is to say corners in one plane, and for three-dimensional corners, that is to say corners in space. These descriptors can be used here. In this case, it is advantageous that characteristic features of the object which can be easily found or identified in the 2-D or 3-D model can be extracted. It is therefore possible to directly compare corresponding details of the object and of the 2-D or 3-D model. This makes it possible to determine the projection pose with a small amount of technical effort. In order to measure the spatial position and/or orientation, one configuration of the invention may provide for an image of the object to be recorded. In this case, it is advantageous that the recorded image can be compared with an image derived from the 2-D or 3-D model. In this case, the 2-D or 3-D model can be rotated and/or shifted until the derived image matches the recorded image. The projection pose can then be calculated from the parameters of the rotation or shifting of the object and is calculated in one configuration.

In order to determine the projection pose, one configuration of the invention may provide for at least one feature to be defined in the 2-D or 3-D model as an orientation aid and for the at least one feature to be identified in the measurement result by means of feature analysis. In this case, it is advantageous that correspondences between the 2-D or 3-D model and the measurement result can be easily obtained from the object and can be used to calculate a projection pose. Edges, corners, points, textures, color and/or brightness values, color and/or brightness differences or other features known from image processing can be used as features, for example. In this case, it is particularly favorable if the measurement result is present in the form of a recorded image. Alternatively or additionally, provision may be made for the measurement result to be provided in the form of a three-dimensional representation of the object, for example by means of the distance measurement described above or by detecting a reference object or a scale. A reference object may be an applied object or a marker or a detected existing object of known or stated size.

For example, such a feature can describe a distinctive shape of the object. The invention therefore makes it possible to easily project marks onto the object in a desired relative position, for example at a desired distance and/or in a desired orientation. For example, such features can be used to identify edges of doors in a wall, the position of room corners, floors and ceilings. This provides reference points, surfaces and spatial structures on which dimensions can be based. The positionally accurate projection according to the invention enables marking which is true to scale.

When providing a 2-D model, the projection pose can be determined by determining a position of a plane described by the 2-D model. This can be carried out, for example, by evaluating one line and one point, two lines, three points, a spatially extended mark or in another manner in order to measure or generally determine or ascertain an inclination or orientation of the object described by the 2-D model.

In order to determine the projection pose, one configuration of the invention may provide for a recorded image, for example the recorded image already mentioned, and/or a three-dimensional representation of the object, for example the three-dimensional representation already mentioned, on the one hand, and the 2-D or 3-D model or a two-dimensional image derived from the latter to be transformed relative to one another until registration is achieved, the projection pose being calculated from parameters of the transformation. Different poses which describe the relevant transformation as a perspective distortion with respect to the pose can therefore be assigned to the parameters of the relative transformation. The projection pose can therefore be directly derived from the parameters. In this case, only the recorded image or the three-dimensional representation or only the 2-D or 3-D model or a two-dimensional image derived therefrom or both can be transformed.

In order to adjust the projector, one configuration of the invention may provide for control of the projector to be calculated in a computer-controlled manner from the projection pose. In this case, it is advantageous that the projector can be adjusted in a computer-assisted manner in fully automatic fashion. This is particularly favorable when the projector is fastened to a projection apparatus which has been set up in a spatially fixed manner, for example on a stand or the like. In this case, the projector can be oriented for the positionally accurate projection by pivoting, tilting or shifting or in another manner. Alternatively or additionally, the projector can be set up for the positionally accurate projection by means of internal or external manipulation, for example by controlling a projection mask or a projection matrix.

Alternatively or additionally, in order to orient the projector during a pivoting movement of the projector, provision may be made for a check to be recurrently carried out in a computer-assisted manner in order to determine whether the projector is oriented for the positionally accurate projection. In this case, it is advantageous that the pivoting movement of the projector can be carried out manually. This can be carried out, for example, by continuously recording images of the object to be examined. The pivoting movement between the images can be calculated in a manner known per se by evaluating a sequence of recorded images if the object does not change or changes only insignificantly between the recordings. A movement detection unit can therefore be provided. For example, provision may be made for an acoustic signal and/or an optical signal to be generated when the positionally accurate projection is achieved in order to indicate to the user that a projection pose in which the desired at least one mark can be projected in a positionally accurate manner has now been reached.

A positionally accurate projection is generally understood as meaning a projection which impinges on the object at that location which is recorded in the 2-D or 3-D model as the location of the predefined at least one mark.

One configuration of the invention may provide for a spatial position and/or orientation of the projector to be measured using a sensor, in particular using an acceleration sensor, a gravitational field sensor, a position sensor or an inertial sensor. This position and/or orientation is/are preferably defined with respect to a gravitational field, for example the Earth's gravitational field. In this case, it is advantageous that spatial indications such as horizontal and/or vertical are available in order to be able to easily characterize, for example, the position and/or orientation of the predefined at least one mark.

A line at an angle of 360° or a full circle or text thereof can therefore be marked by positionally accurate projection, for example by rotating the projection apparatus or at least the projector. In this case, it is advantageous that an entire projection can therefore be carried out for a “water” line. Alternatively or additionally, instead of an orientation with respect to the Earth's gravitational field, marks, for example lines, can also be imaged with respect to objects or parts of the latter by means of positionally accurate projection.

In order to achieve the object mentioned and in particular in the method according to the invention already described, the invention provides, in the case of a projection apparatus of the type described at the outset, for the recording and/or measuring apparatus to be set up to measure a spatial position and/or orientation of an object, for a computing unit to be set up to determine a projection pose of the projector with respect to the measured spatial position and/or orientation of the object in a computer-assisted manner by comparing a measurement result of the measurement with a stored 2-D or 3-D model of the object, and for the projection apparatus to be set up to adjust the projector on the basis of the projection pose for positionally accurate projection of at least one mark in the 2-D or 3-D model onto the object. In this case, it is advantageous that a handheld projection apparatus and/or a projection apparatus which can be mounted on a stand is provided and can be used to carry out the method according to the invention described. The projector can be adjusted, for example, by being set up or oriented in the described manner.

One configuration of the invention may provide for the computing unit to be set up to calculate control of the projector in a computer-assisted manner for positionally accurate projection of the at least one mark onto the object. In this case, it is advantageous that fully automatic positionally accurate projection can be carried out by accordingly orienting the projector and/or by filling the one projection mask of the projector, for example, according to the set-up of the projector.

In this case or in another configuration of the invention, provision may be made for a control unit to be set up to control the projector in a computer-assisted manner for the positionally accurate projection of the at least one mark onto the object. In this case, it is advantageous that there is no need to manually intervene in the projection process. In particular, there is therefore no need to pivot the projector in order to achieve positionally accurate projection.

In this case or in another configuration of the invention, provision may be made for the projector to have an adjustment device which is set up to adjust the projector relative to the recording and/or measuring apparatus. In this case, it is advantageous that a defined relative orientation of the projector relative to the recording and/or measuring apparatus can be set, with the result that a defined spatial orientation of the projector, namely the absolute orientation predefined by the relative orientation, can be predefined through the spatial orientation of the recording and/or measuring apparatus. In this case, it is also advantageous that the projector can be controlled in a computer-assisted manner in order to project the desired at least one mark, for example a point, a line or a more complex pattern such as a wiring diagram and/or a circuit diagram of a building wall or another object, onto the object.

Alternatively, provision may be made for the projector to be rigidly coupled to the recording and/or measuring apparatus. In this case, it is advantageous that a pose of the recording and/or measuring apparatus can be directly converted into the projection pose. Therefore, a projection pose of the projector can be calculated from a recording and/or measuring pose of the recording and/or measuring apparatus at the recording or measuring time since the projector is rigidly carried along with the recording and/or measuring apparatus.

One configuration of the invention may provide for the recording and/or measuring apparatus to have a camera. In this case, it is advantageous that images of the object to be examined can be recorded and can be used to calculate, for example in the manner described, a camera pose using features and/or perspective laws of the imaging process and to calculate a projection pose using the coupling mentioned.

Alternatively or additionally, provision may be made for the recording and/or measuring apparatus to have a distance measuring apparatus. In this case, it is advantageous that it is possible to measure distances between the object to be examined and the recording and/or measuring apparatus and therefore distances from the projector. The distance measuring apparatus is preferably in the form of a distance scanner in order to be able to measure a multiplicity of distances from different points of the object.

One configuration of the invention may provide for the projector to have a laser pointer. In this case, it is advantageous that punctiform marks can be easily projected. It is also advantageous in this case that more complex marks such as line systems and the like can be projected by controlling the laser pointer, for example by means of pivoting or other adjustment by means of an adjustment device.

One configuration of the invention may provide for the projector to have at least one pivotable mirror. In this case, it is advantageous that there is no need to pivot the projector itself. With a corresponding design of the mirror, fast switching operations can thus be carried out in order to project a complex line pattern composed of individual points and/or lines for the observer.

Alternatively or additionally, provision may be made for the projector to be set up to project a two-dimensional pattern. For example, a corresponding projection mask or projection matrix may be provided for this purpose and can be or is controlled according to the mark to be projected. This control adjusts the projector. In this case, it is advantageous that a multiplicity of items of information and therefore a multiplicity of different marks of any desired shape can be displayed at the same time.

One configuration of the invention may provide for the recording and/or measuring apparatus to be integrated in the projector. In this case, it is advantageous that a space-saving robust projection apparatus can be provided. For example, the projector may be set up as a laser pointer and the recording and/or measuring apparatus may be set up as a laser-assisted distance measuring apparatus.

One configuration of the invention may provide for a sensor, in particular an acceleration sensor or a gravitational field sensor, to be designed to measure a spatial position and/or orientation of the projector. It is also possible to advantageously use other sensors, for example rotation rate sensors or other inertial sensors. In this case, it is advantageous that the position and the course of a horizontal and/or vertical line can be easily determined. This is favorable, for example, in construction where dimensions or positions often have to be communicated using a horizontal and/or a vertical connecting line.

It is therefore possible to display, for example, lines in the projection which extend in the horizontal or vertical direction with respect to the at least one mark or with respect to a reference point on the object, for example at a predefined distance from the at least one mark or the reference point.

One configuration of the invention may provide for the computing unit to be set up to transform in a computer-assisted manner a recorded image, for example the recorded image already mentioned, and/or a three-dimensional representation of the object, for example the three-dimensional representation of the object mentioned, on the one hand, and the 2-D or 3-D model, on the other hand, relative to one another in a computer-assisted manner until registration is achieved. In this case, it is advantageous that a projection pose of the projector can be calculated using simple geometrical laws from parameters of the transformation needed for the registration.

One configuration of the invention may provide for the computing unit to be set up to calculate a three-dimensional representation of the object from measurement results from the recording and/or measuring apparatus. In this case, it is advantageous that a three-dimensional representation can be obtained and can be directly processed with the 2-D or 3-D model. It is therefore possible to dispense with simulations of the recording and/or measuring process. The three-dimensional representation of the object can be calculated, for example, from recorded images and/or from at least one measured distance, preferably in the manner already described.

It is particularly favorable if the projection apparatus has means for carrying out the method according to the invention, in particular the method described above and/or the method claimed in one of the claims directed to a method. In this case, it is advantageous that the advantages of a method according to the invention can be combined with the advantages of a projection apparatus according to the invention.

The projection apparatus is preferably in the form of a handheld device.

The invention is now described in more detail using exemplary embodiments but is not restricted to these exemplary embodiments. Further exemplary embodiments emerge from a combination of the features of individual claims or a plurality of claims with one another and/or with individual features or a plurality of features of the exemplary embodiments.

### BRIEF DESCRIPTION OF THE DRAWINGS

In a highly simplified basic illustration for explaining the concept of the invention:

FIG. 1 shows the use of a projection apparatus according to the invention in a method according to the invention,

FIG. 2 shows the positionally accurate projection of a mark using the projection apparatus according to the invention in accordance with FIG. 1,

FIG. 3 shows a further projection apparatus according to the invention with an adjustable projector,

FIG. 4 shows a further projection apparatus according to the invention with an adjustable mirror,

FIG. 5 shows a further projection apparatus according to the invention with a wirelessly connected display means,

FIG. 6 shows the positionally accurate projection in the method according to the invention using a projection apparatus according to the invention in accordance with FIG. 5,

FIG. 7 shows a first step of a further exemplary embodiment of the method according to the invention,

FIG. 8 shows a second step of the exemplary embodiment in accordance with FIG. 7,

FIG. 9 shows the positionally accurate projection of at least one mark in the method in accordance with FIG. 7 and FIG. 8, and

FIG. 10 shows an enlarged illustration of the detail K of the display means of the projection apparatus in the method in accordance with FIG. 7 to FIG. 9.

### DETAILED DESCRIPTION OF THE PREFERRED EMBODIMENTS

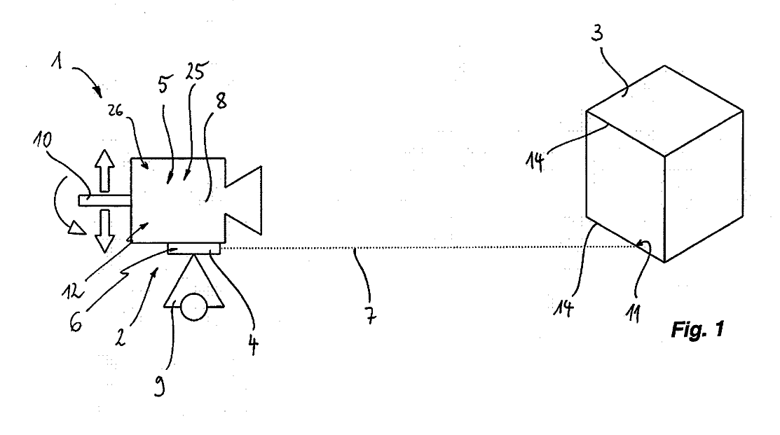

FIG. 1 shows a highly simplified basic illustration of a projection apparatus according to the invention denoted on the whole with 1.

The projection apparatus 1 has a recording and/or measuring apparatus 2 which is set up to measure a spatial position and/or orientation of an object 3, as is described in yet more detail below.

The projection apparatus 1 also has a projector 4 which can be used to project any desired marks, for example points, lines, circles or other geometrical shapes or other more complex patterns, onto the object 3.

The recording and/or measuring apparatus 2 and the projector 4 are permanently connected to one another and are therefore rigidly coupled, with the result that a defined spatial orientation of the projector 4 is predefined by the spatial orientation of the recording and/or measuring apparatus.

A computing unit 5 which can be used to evaluate measurement results from the recording and/or measuring apparatus 2 is arranged inside the projection apparatus 1.

In this case, the computing unit 5 is set up by means of programming in such a manner that a projection pose of the projector 4 coupled to the recording and/or measuring apparatus 2 can be calculated from the measured spatial position and orientation of the object 3.

In order to create the measurement result, the recording and/or measuring apparatus 2 has a distance measuring apparatus 6 which is integrated, in a manner known per se, in the projector 4 in the form of a laser pointer in order to measure distances.

For this purpose, the projector 4 generates a laser beam 7 which is aimed at the object 3 in order to measure a distance using the distance measuring apparatus 6. The projector 4 can therefore be changed over between a projection mode and a distance measuring mode.

The recording and/or measuring apparatus 2 also has a camera 8 which can be used to record an image of the object 3.

The recording and/or measuring apparatus 2 is rotatably and/or pivotably mounted on a stand 9 and can be tilted or pivoted at least in the directions indicated by the arrows by a handle 10. As a result, the laser beam 7 moves over the object 3.

The computing unit 5 can detect a pivoting movement of the recording and/or measuring apparatus 2 and therefore of the distance measuring apparatus 6 by evaluating a sequence of recorded images of the object 3. The computing unit 5 therefore forms a movement detection unit 25 with the camera 8.

A multiplicity of distances from different impingement points 11 of the laser beam 7 on the object 3 can therefore be measured by pivoting or tilting the recording and/or measuring apparatus 2 in the degrees of freedom predefined by the stand 9. A distance scan can therefore be carried out on the object 3.

Detecting the pivot or tilt angle of the projector 4 using the computing unit 5 therefore results in an item of angle-dependent distance information which can be used to calculate a three-dimensional representation of the object, for example by representing the important shapes of the object 3, in the computing unit 5.

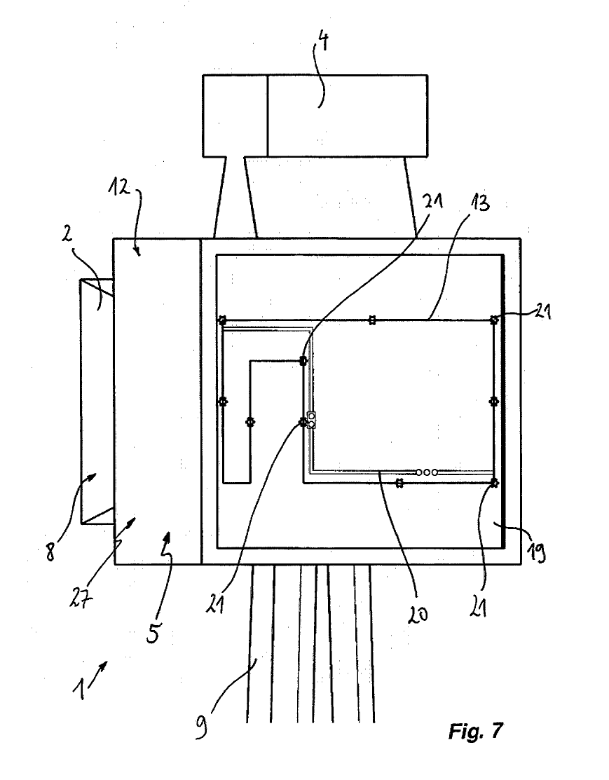

A 3-D model 13 which is not illustrated further (cf. FIG. 7, but here in the form of a cube corresponding to the illustrated object 3) is stored in a memory 12 inside the projection apparatus 1. Instead of the 3-D model 13, a 2-D model describing a flat object is stored in an alternative.

The computing unit 5 compares the 3-D model with the calculated three-dimensional representation of the object 3 and applies a transformation comprising elementary shifting, rotating and/or scaling operations to the 3-D model and/or the three-dimensional representation in order to determine the pose from which the three-dimensional representation of the object 3 was recorded.

Since the projector 4 is permanently coupled to the recording and/or measuring apparatus 2, this results in the projection pose of the projector 4 at the time at which the three-dimensional representation of the object 3 was recorded.

In order to generate the three-dimensional representation, the recording and/or measuring apparatus 2 is adjusted manually in order to guide the laser beam 7 over the object 3.

In this respect, it is particularly favorable if the user guides the laser beam 7 in proximity to an edge 14 on the object 3 in order to scan the edge 14 using the distance measuring apparatus 6.

A corresponding edge which can be identified in a particularly simple manner from the 3-D model as a corresponding detail results in this manner from the distance scan in the three-dimensional representation. This makes it easier to determine the projection pose of the projector 4.

FIG. 1 shows the scanning of an edge 14 of the object 3, in which the laser beam 7 is guided transversely with respect to the direction of extent of this edge 14 using the handle 10. This process is actually repeated for further edges of the object.

After gaining knowledge of the projection pose of the projector 4, a mark which is predefined in the 3-D model can now be projected onto the object in a positionally accurate manner.

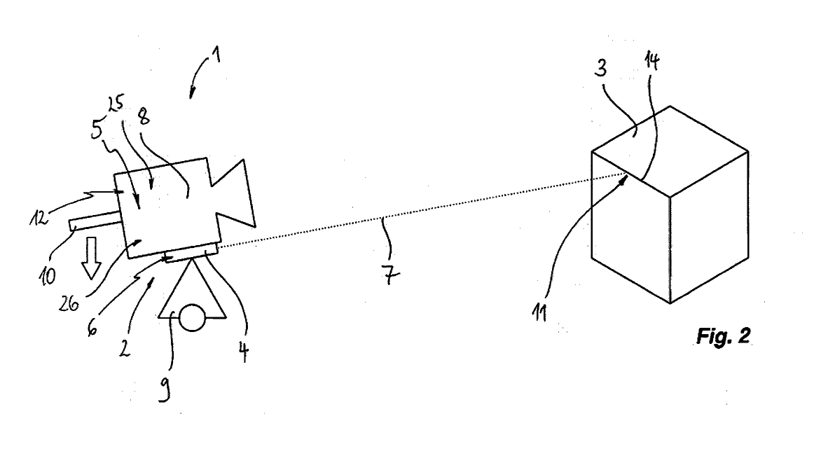

For the explanation of the invention, it is assumed that a mark in the form of a point at a location corresponding to the impingement point 11 in FIG. 2 is predefined in the 3-D model of the object 3.

The user now pivots the projection apparatus 1 until the laser beam 7 reaches this impingement point 11. In this case, the pivot angle is determined in the manner already described by recording an image of the object 3 in the camera 8 and then preprocessing a sequence of recorded images using the movement detection unit 25.

If this impingement point 11 has been reached, the projection apparatus 1 generates an acoustic and/or optical signal which indicates to the user that the impingement point 11 for the positionally accurate projection of the mark from the 3-D model has been reached.

The laser beam 7 therefore indicates the position of this mark on the object 3 in a positionally accurate manner.

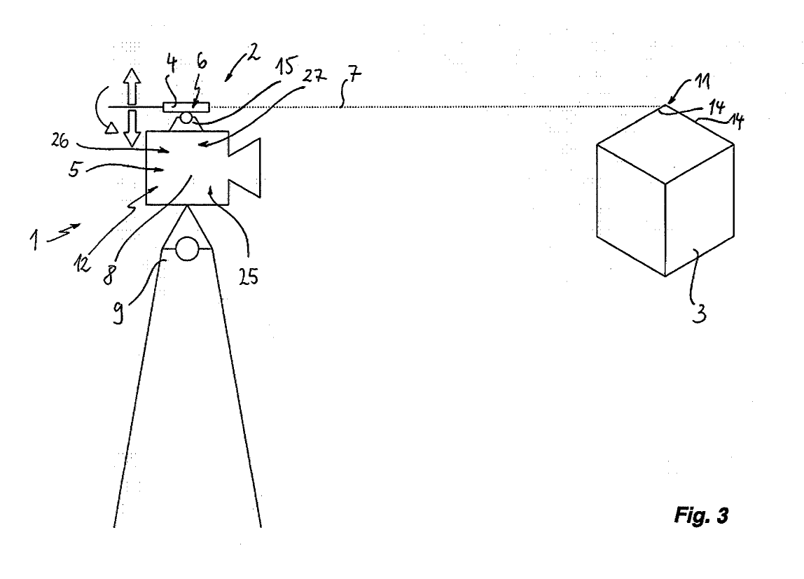

FIG. 3 shows a further projection apparatus 1 according to the invention. Details which are similar or identical to the exemplary embodiment in accordance with FIGS. 1 and 2 in terms of design and/or function are denoted using the same reference symbols in FIG. 3 and are not described separately again. The statements made with respect to FIGS. 1 and 2 therefore accordingly apply to FIG. 3.

The exemplary embodiment in accordance with FIG. 3 differs from the preceding exemplary embodiment in that the projector 4 and the camera 8 of the recording and/or measuring apparatus 2 are not rigidly coupled but rather are coupled to one another via an adjustment device 15.

In a manner known per se, this adjustment device 15 is set up to measure the respectively set angle between the projector 4 and the camera 8. With knowledge of the pose of the camera 8, a defined projection pose of the projector 4 can therefore be predefined by accordingly actuating or adjusting the adjustment device 15.

In the exemplary embodiment in accordance with FIG. 3 as well, the projector 4 is additionally set up as a distance measuring apparatus 6 for measuring a distance using the laser beam 7.

In contrast to the preceding exemplary embodiment, only the distance measuring apparatus 6, rather than the entire projection apparatus 1, is now pivoted during the creation of the three-dimensional representation. In this case, the camera 8 remains aimed at the object 3 in a spatially fixed manner.

The computing unit 5 again constructs a three-dimensional representation from the measured distances between the distance measuring apparatus 6 and the respective impingement point 11 and the respectively associated angles at the adjustment device 15.

This can be additionally assisted by virtue of the impingement points 11 each being identified in recorded images from the camera 8.

After the three-dimensional representation has been compared with the stored 3-D model in the manner described above, the adjustment device 15 is now automatically controlled in order to project a mark predefined in the 3-D model, for example a point, a line or another geometrical pattern, onto the object 3 in a positionally accurate manner.

For this purpose, the corresponding control for the adjustment device 15 is calculated in the computing unit 5 from the projection pose and is transmitted to a control unit 27 of the adjustment device 15.

An acceleration sensor 26 which can be used to measure the orientation of the projection apparatus 1 in the Earth's gravitational field is also arranged in the projection apparatus 1. An item of information which indicates a horizontal orientation and a vertical orientation is available in this manner. The adjustment device 15 can now be controlled in such a manner that the projector 4 is pivoted in order to draw a horizontal or vertical line on the object 3. In further exemplary embodiments, instead of the acceleration sensor 26, another sensor, for example a position sensor or an inertial sensor such as a gyroscope, is provided for the purpose of determining the orientation in the Earth's gravitational field.

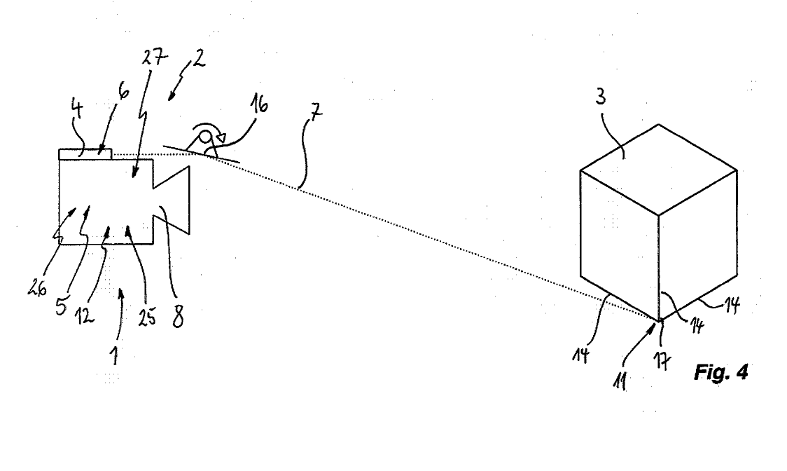

FIG. 4 shows a further exemplary embodiment of the invention. Design and/or functional details which are identical or similar to the preceding exemplary embodiments are denoted using the same reference symbols in FIG. 4 and are not described separately again. The statements made with respect to FIGS. 1 to 3 therefore accordingly apply to FIG. 4.

The projection apparatus 1 in accordance with FIG. 4 differs from the preceding exemplary embodiments in that the projector 4 is rigidly coupled to the camera 8, at least one adjustable mirror 16 additionally being provided, which mirror can move the laser beam 7 to different impingement points 11 of the object 3 in order to carry out a plurality of distance measurements.

A three-dimensional representation can therefore be calculated from the distance information from the actuating angle of the adjustable angle 16 and the imaging of the impingement point 11 in an image recorded by the camera 8.

FIG. 4 shows the situation in which the impingement point 11 is at a corner 17 formed by three converging edges 14.

The corner 17 is produced in the three-dimensional representation by virtue of the three edges 14 being scanned in succession.

The adjustable mirror 16 can be manually adjusted, but can be automatically controlled in one exemplary embodiment in order to carry out a predefined scanning process for the purpose of detecting the object 3.

After the projection pose of the projector 4 has been determined in the manner already described, the adjustable mirror 16 is controlled by the computing unit 5 in such a manner that the laser beam 7 is aimed at a position indicated by at least one mark in the stored 3-D model in a positionally accurate manner on the object 3. The projector 4 is therefore automatically adjusted, that is to say set up in this case, for the positionally accurate projection of the desired mark.

This mark is therefore projected in a positionally accurate manner.

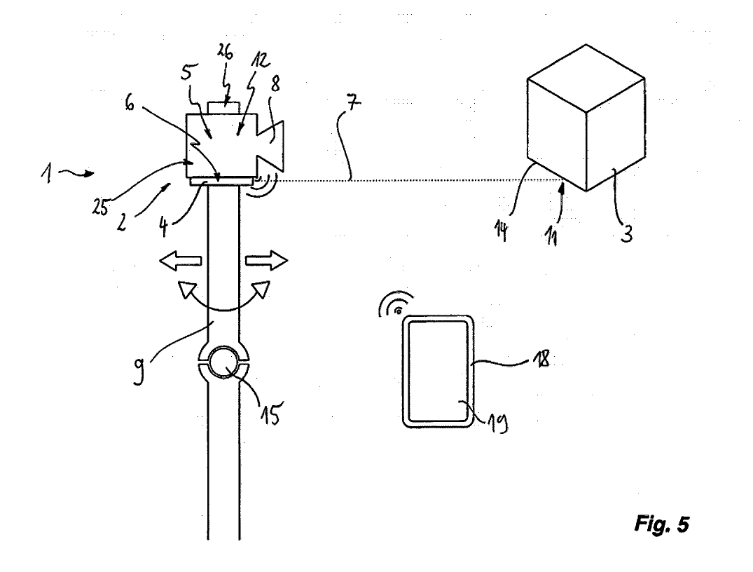

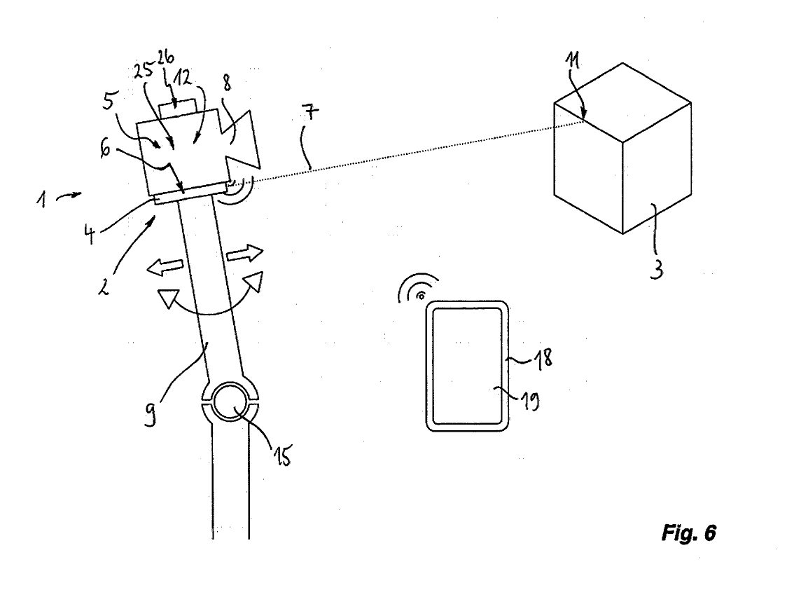

FIG. 5 shows a further exemplary embodiment of a projection apparatus 1 according to the invention. Design details and/or details which are functionally similar or identical to the preceding exemplary embodiments are denoted using the same reference symbols and are not described separately again. The statements made with respect to FIGS. 1 to 4 therefore accordingly apply to FIGS. 5 and 6.

FIG. 5 shows the creation of a three-dimensional representation of the object 3 in the computing unit 5.

In this case, the projection apparatus 1 is arranged on a stand 9 which can be moved by motor. The projection apparatus 1 having the recording and/or measuring apparatus 2 and the rigidly coupled projector 4 can be pivoted via a wirelessly connected operating unit 18 in order to guide the laser beam 7 over the object 3.

Detecting the associated adjustment angles of the adjustment device 15 again results in a three-dimensional representation of the object 3.

The calculated three-dimensional representation of the object 3 is then compared with the stored 3-D model for the object 3 in order to calculate the pose of the projector 4 relative to the object 3, that is to say the position and orientation of the projector 4 at which the distance measurements were carried out.

The computing unit 5 uses this projection pose to control the adjustment device 15 in order to move the laser beam 7 to the positionally accurate position on the object 3 with respect to a mark in the 3-D model. FIG. 6 shows this situation. The projector 4 is therefore automatically adjusted for the positionally accurate projection by the computing unit 5. This is carried out here by virtue of the projector 4 being accordingly oriented by the integrated control unit 27 via the adjustment device 5 of the stand 9.

It is also clear in FIG. 5 that an acceleration sensor 26 in the form of an inclination sensor is fitted to the outside of the projection apparatus 1.

This acceleration sensor 26 is used to measure an orientation of the projection apparatus 1 in the Earth's gravitational field, with the result that a horizontal direction and a vertical direction and directions at any desired angle with respect to the horizontal or vertical direction are available as reference lines for the positionally accurate projections.

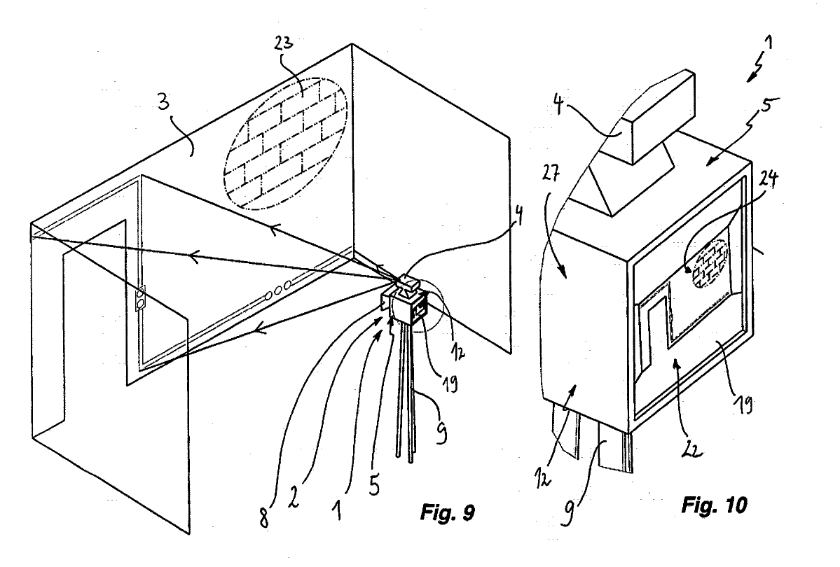

FIG. 7 to FIG. 9 show a further exemplary embodiment of the invention. Details which are identical or similar to the preceding exemplary embodiments in terms of function and/or design are denoted using the same reference symbols in FIGS. 7 to 10 and are not described separately again. The statements made with respect to FIGS. 1 to 6 therefore accordingly apply to FIGS. 7 to 10.

The method in FIGS. 7 to 10 therefore begins with a 3-D model 13 of an object 3 being provided in a projection apparatus 1. The 3-D model 13 does not reproduce all details of the real object 3. For example, the 3-D model 13 does not contain the wall structure 23 of the object 3.

A mark 20 is predefined in this 3-D model 13.

In order to illustrate the invention, a wall of a room, at which an electrical line is defined in the 3-D model 13 as a mark 20, is illustrated as an object 3 here by way of example. However, any other desired objects and marks can also be used.

The user would like to display this mark 20 on the object 3 in a positionally accurate manner in order to determine the actual position of this electrical line.

It is clear in FIG. 7 that the 3-D model 13 stores orientation aids 21 which describe automatically identifiable features of the 3-D model 13.

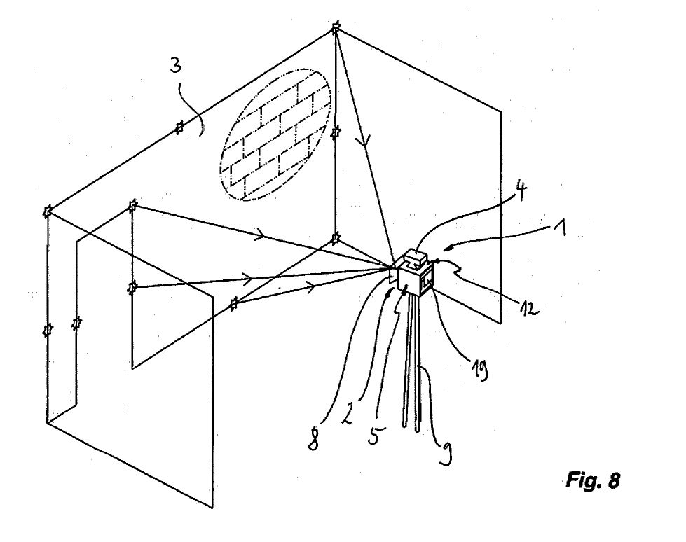

In a next step (FIG. 8), an image 22 of the object 3 is recorded using the camera 8.

The features of the orientation aids 21 are searched for in this image in a computer-assisted manner by means of feature analysis.

The position of these automatically identified features of the orientation aids 21 in the recorded image 22 of the object 3 is then used in the computing unit 5 to calculate the pose at which the object 3 was recorded. For this purpose, the recorded image 22 having the identified orientation aids 21 is compared with an image derived from the 3-D model 13. The two images are transformed with respect to one another in a computer-assisted manner until registration of the orientation aids 21 is achieved. The pose of the camera 8 at the recording time then results from parameters of this transformation using known geometrical and perspective laws.

The projector 4 is rigidly coupled to the camera 8 of the recording and/or measuring apparatus 2, with the result that the projection pose of the projector 4 can be calculated from the pose of the camera 8.

With knowledge of this projection pose, the computing unit 5 now calculates control of the projector 4 in order to project the mark 20 onto the object 3 in a positionally accurate manner. This control is transmitted to an integrated control unit 27 which accordingly adjusts the projector 4. As a result of this control, the projector 4 is therefore adjusted for the positionally accurate projection, here set up by defining a projection mask, in particular. In this case, the projector 4 is set up to project a two-dimensional pattern.

For the purpose of monitoring, the object 3 is again recorded using the camera 8 and is represented on a display means 19 (FIG. 10).

By comparing the representations on the display means 19 in FIG. 7 and FIG. 10, it is clear that the mark 20 in the image 22—discernible from the image 24 of the wall structure 23 which is not included in the 3-D model 13—has been projected in a positionally accurate manner.

It is also clear in the figures that the projection apparatus 1 is respectively equipped with a movement detection unit 25 which has already been mentioned and is arranged inside the projection apparatus 1. This movement detection unit 25 is used to detect pivoting movements and/or shifting of the recording and/or measuring apparatus 2, for example in the manner already described by evaluating a sequence of images recorded using the camera 8. For this purpose, it is possible to calculate an optical flow in these images, for example, from which a corresponding movement of the recording and/or measuring apparatus 2 can be calculated with a substantially unchanged object.

An acceleration sensor 26 is additionally arranged in the projection apparatuses 1 of the exemplary embodiments shown and can be and is used to measure an orientation of the projection apparatus 1 in the Earth's gravitational field. The output signal from this acceleration sensor 26 is used to be able to indicate horizontal or vertical lines or lines at a particular angle with respect to the horizontal or vertical direction in the projection or to be able to use them as reference lines for calculating projections. Therefore, a horizontal line, the so-called “water” line, can be marked, for example, along an angular range, in particular along a full circle of 360°, by rotating the projector 4 or by means of other suitable control.

In a further exemplary embodiment, the recording and/or measuring apparatus 2 is formed by the projector 4 and the camera 8, the orientation of the projector 4 being calibrated with respect to an optical axis of the camera 8. An imaging distance from the object 3 is determined by determining an image position of the impingement point 11 of the laser beam 7 on the object 3 in an image recorded using the camera 8. Details of this are described in DE 10 2010 005 042 B3. As a result of the object 3 being scanned with a laser beam 7, a three-dimensional representation of the object 3 is again calculated and is used to calculate a projection pose of the projector 4 by comparison with the stored 3-D model 13. Controlling the projector 4 adjusts the latter for the positionally accurate projection of a mark in the manner already described.

In the case of the projection apparatus 1, it is provided to measure a spatial position and/or orientation of an object 3 using a recording and/or measuring apparatus 2, to calculate a projection pose of a projector 4 from a result of this measurement and to adjust the projector 4 in such a manner that a mark 20 predefined in a 2-D or 3-D model 13 of the object 3 is projected onto the project 3 in a positionally accurate manner.

1. A method for the positionally accurate projection of a mark (20) onto an object (3), comprising the following steps:
providing a 2-D or 3-D model (13) of the object (3) in a computer-assisted manner,
predefining at least one mark (20) in the 2-D or 3-D model (13),
measuring at least one of the a spatial position or orientation of the object (3),
determining a projection pose of a projector (4) with respect to the at least one of spatial position or the orientation of the object (3) that was measured in a computer-assisted manner by comparing a measurement result of the measurement with the 2-D or 3-D model (13),
adjusting the projector (4) based on the projection pose for positionally accurate projection of the at least one mark (20) onto the object (3), and
projecting the at least one mark (20) onto the object (3) in a positionally accurate manner based on a calculated control.

2. The method as claimed in claim 1, wherein in order to measure the at least one of spatial position or the orientation, the method further comprises measuring at least one distance between a projection apparatus (1) having the projector (4) and the object (3), or in order to measure the spatial position, the method further comprises calculating a three-dimensional representation of the object (3) from at least one distance between a projection apparatus (1) having the projector (4) and the object (3) or from a sequence of recorded images of the object and is compared with the 2-D or 3-D model (13).

3. The method as claimed in claim 1, wherein in order to measure the at least one of the spatial position or orientation of the object (3), the method further comprises detecting at least one feature of the object (3), or in order to measure the at least one of the spatial position or the orientation, the method further comprises recording an image (22) of the object (3).

4. The method as claimed in claim 1, wherein in order to determine the projection pose, the method further comprises defining at least one feature in the 2-D or 3-D model (13) as an orientation aid (21) and the at least one feature is identified in the measurement result.

5. The method as claimed in claim 1, wherein in order to determine the projection pose, the method further comprises transforming at least one of a recorded image (22) of the object or a three-dimensional representation of the object (3), on the one hand, and the 2-D or 3-D model (13), on the other hand, relative to one another in a computer-assisted manner until registration is achieved, and calculating the projection pose from parameters of the transformation.

6. The method as claimed in claim 1, wherein in order to adjust the projector (4), the method further comprises calculating control of the projector (4) in a computer-assisted manner from the projection pose, or in that, in order to adjust the projector (4) the method further comprises recurrently carrying out during a pivoting movement of the projector (4), a check in a computer-assisted manner in order to determine whether the projector (4) is oriented for the positionally accurate projection.

7. The method as claimed in claim 1, further comprising measuring at least one of a spatial position or orientation of the projector (4) using a sensor.

8. A projection apparatus (1) comprising at least one of a recording or measuring apparatus (1) and a projector (4), the projector (4) being coupled to the at least one of the recording or measuring apparatus (2) in such a manner that a defined spatial orientation of the projector (4) is predefined or is predefinable by a spatial orientation of the at least one of the recording or measuring apparatus (2), the at least one of the recording or measuring apparatus (2) is set up to measure at least one of a spatial position or orientation of an object (3), a computing unit (5) configured to determine a projection pose of the projector (4) with respect to the at least one of the spatial position or the orientation of the object (3) that is measured in a computer-assisted manner by comparing a measurement result of the measurement with a stored 2-D or 3-D model (13) of the object (3), and the projection apparatus (1) is configured to adjust the projector (4) based on the projection pose for positionally accurate projection of at least one mark (20) in the 2-D or 3-D model (13) onto the object (3).

9. The projection apparatus (1) as claimed in claim 8, wherein the computing unit (5) is configured to calculate control parameters for the projector (4) in a computer-assisted manner for positionally accurate projection of the at least one mark (20) onto the object (3), or a control unit (27) is configured to control the projector (4) in a computer-assisted manner for the positionally accurate projection of the at least one mark (20) onto the object (3).

10. The projection apparatus (1) as claimed in claim 8, wherein the projector (4) has an adjustment device (15) which is configured to adjust the projector (4) relative to the at least one of the recording or measuring apparatus, or the projector (4) is rigidly coupled to the at least one of the recording or measuring apparatus (2).

11. The projection apparatus (1) as claimed in claim 8, wherein the at least one of the recording or measuring apparatus (2) has a camera (8), or the at least one of the recording or measuring apparatus (2) has a distance measuring apparatus (6), or both.

12. The projection apparatus (1) as claimed in claim 8, wherein the projector (4) has a laser pointer, or in that the projector (4) has at least one adjustable mirror (16), or both.

13. The projection apparatus (1) as claimed in claim 8, wherein the projector (4) is set up to project a two-dimensional pattern.

14. The projection apparatus (1) as claimed in claim 8, wherein the at least one of the recording or measuring apparatus (2) is integrated in the projector (4), or a sensor is provided that measures at least one of a spatial position or orientation of the projector (4), or both.

15. The projection apparatus (1) as claimed in claim 8, wherein the projection apparatus (1) has a movement detection unit (25) which is configured to detect a pivoting movement of the projector (4).

16. The projection apparatus (1) as claimed in claim 8, wherein the computing unit (5) is configured to transform in a computer-assisted manner a recorded image (22) or a three-dimensional representation of the object (3), on the one hand, and the 2-D or 3-D model (13), on the other hand, relative to one another in a computer-assisted manner until registration is achieved, or the computing unit (5) is configured to calculate a three-dimensional representation of the object (3) from measurement results from the at least one of the recording or measuring apparatus (2).
